(19) United States
(12) Patent Application Publication
(10) Pub. No.: US 2026/0351969 A1
(43) Pub. Date: Nov. 5, 2026

(54) SYSTEM AND METHOD FOR REDUCING POWER OSCILLATIONS GENERATED BY INVERTER-BASED RESOURCES AND BEING INJECTED INTO THE GRID

(71) Applicant: General Electric Renovables España, S.L., Barcelona (ES)

(72) Inventor: Dustin Howard, Brookhaven, GA (US)

(21) Appl. No.: 19/105,129

(22) PCT Filed: Aug. 23, 2022
(86) PCT No.: PCT/US2022/041198

§ 371 Date: Feb. 20, 2025

(51) Int. Cl. H02J 3/0014; H02J 3/32; H02J 3/38; H02J 3/50; H02J 101/28

(52) U.S. Cl. CPC H02J 3/00142; H02J 3/32; H02J 3/381; H02J 3/50; H02J 2101/28

(57) ABSTRACT

A method for reducing power oscillations generated by a system of inverter-based resources and being injected into an electrical grid includes communicatively coupling a system-level energy buffer circuit with a system-level controller. The system-level controller communicatively is coupled to local controllers of the inverter-based resources. The method also includes generating, via the system-level energy buffer circuit, an energy buffer for the system of inverter-based resources.

Further, the method includes applying the energy buffer to the power oscillations generated by the system of inverter-based resources so as to decouple the power oscillations generated by the system of inverter-based resources from a total output power of the system of inverter-based resources.

### FIELD

The present disclosure relates generally inverter-based resources (IBRs) and, more particularly, to systems and methods for decoupling drivetrain-related power oscillations from the active power injected into the grid, thereby allowing the IBRs to manage loading on the drivetrain independent of grid conditions.

### BACKGROUND

Wind power is considered one of the cleanest, most environmentally friendly energy sources presently available and wind turbines have gained increased attention in this regard. A modern wind turbine typically includes a tower, a generator, a gearbox, a nacelle, and one or more rotor blades. The rotor blades are the primary elements for converting wind energy into electrical energy. The blades typically have the cross-sectional profile of an airfoil such that, during operation, air flows over the blade producing a pressure difference between its sides. Consequently, a lift force, which is directed from the pressure side towards the suction side, acts on the blade. The lift force generates torque on the main rotor shaft, which is connected to a generator for producing electricity that is transferred to a power grid. The power grid transmits electrical energy from generating facilities to end users.

Wind power generation is typically provided by a wind farm, which contains a plurality of wind turbine generators (e.g., often 100 or more). Typical wind farms have a farm-level controller that regulates the voltage, reactive power, and/or power factor at the wind farm interconnection point (i.e., the point at which the local wind turbine generators are connected to the grid; may also be referred to as the point of common coupling). In such wind farms, the farm-level controller achieves its control objectives by sending reactive power or reactive current commands to the individual wind turbine generators within the wind farm. However, certain constraints of the local wind turbine generators within the wind farm can constrain the capability to supply reactive power. Such constraints, may include, for example, voltage limits, reactive power limits, and/or current limits.

Modern day wind-turbine generators (WTGs) utilize grid-connected power converters to achieve certain special dynamic control functions (in addition to the primary control functions of regulating speed and power), such as damping drivetrain torsional oscillations and damping tower oscillations. These control functions change the active power injected into the grid at a particular frequency. The power oscillation components are usually at a known frequency dictated by the dimensions and physics of the WTG. These control functions are practical since grid-forming resources (mostly synchronous machines) are abundantly available in most applications such that these other resources can accommodate the change in active power injected by the WTG.

WTGs are a type of inverter-based resource (IBR), which connotes an inverter that converts direct current (DC) to alternating current (AC) and which may be used to interface any energy source to an ac power system. Thus, the energy sources can possibly include, but are not limited to, a renewable source such as solar photovoltaic array, wind turbine, battery energy storage, ultracapacitor or fossil-fuel based source such as a diesel or natural gas genset, STATCOM, HVDC VSC, or any combination of these energy sources tied to a DC network. Furthermore, IBRs can be operated in a grid-following mode or a grid-forming mode.

As used herein, grid-following type devices utilize fast current-regulation loops to control active and reactive power exchanged with the grid. More specifically, the active power reference to the converter is developed by an energy source regulator, e.g., the turbine control portion of a wind turbine. This is conveyed as a torque reference, which represents the lesser of the maximum attainable power from the energy source at that instant, or a curtailment command from a higher-level grid controller. The converter controller then determines a current reference for the active component of current to achieve the desired torque. Accordingly, the WTG includes functions that manage the voltage and reactive power in a manner that results in a command for the reactive component of current. Wide-bandwidth current regulators then develop commands for voltage to be applied by the converters to the system, such that the actual currents closely track the commands.

Alternatively, grid-forming type converters provide a voltage-source characteristic, where the angle and magnitude of the voltage are controlled to achieve the regulation functions needed by the grid. With this structure, current will flow according to the demands of the grid while the converter contributes to establishing a voltage and frequency for the grid. This characteristic is comparable to conventional generators based on a turbine driving a synchronous machine. Thus, a grid-forming source must include the following basic functions: (1) support grid voltage and frequency for any current flow within the rating of the equipment, both real and reactive; (2) prevent operation beyond equipment voltage or current capability by allowing grid voltage or frequency to change rather than disconnecting equipment (disconnection is allowed only when voltage or frequency are outside of bounds established by the grid entity); (3) remain stable for any grid configuration or load characteristic, including serving an isolated load or connected with other grid-forming sources, and switching between such configurations; (4) share total load of the grid among other grid-forming sources connected to the grid; (5) ride through grid disturbances, both major and minor, and (6) meet requirements (1)-(5) without requiring fast communication with other control systems existing in the grid, or externally-created logic signals related to grid configuration changes.

In the coming years, many of the synchronous machines connected to grids may be retired. A consequence of this structural change to the grid is that the ability of IBRs, such as a group of WTGs, to freely change power into the grid may be more constrained. For this reason, alternative resources that can supply the power needs for these control functions would be beneficial.

Accordingly, the present disclosure is directed to a system and method for decoupling drivetrain-related power oscillations from the active power injected into the grid, thereby allowing the WTG(s) to manage loading on the drivetrain independent of grid conditions.

### BRIEF DESCRIPTION

Aspects and advantages of the invention will be set forth in part in the following description, or may be obvious from the description, or may be learned through practice of the invention.

In an aspect, the present disclosure is directed to a method for reducing power oscillations generated by a system of inverter-based resources and being injected into an electrical grid. The method includes communicatively coupling a system-level energy buffer circuit with a system-level controller. The system-level controller communicatively is coupled to local controllers of the inverter-based resources. The method also includes generating, via the system-level energy buffer circuit, an energy buffer for the system of inverter-based resources. Further, the method includes applying the energy buffer to the power oscillations generated by the system of inverter-based resources so as to decouple the power oscillations generated by the system of inverter-based resources from a total output power of the system of inverter-based resources.

In another aspect, the present disclosure is directed to a wind farm connected to an electrical grid. The wind farm includes a plurality of wind turbine generators, a farm-level controller, and a farm-level energy buffer circuit for reducing power oscillations generated by the plurality of wind turbine generators and being injected into the electrical grid. The farm-level energy buffer circuit is communicatively coupled with the farm-level controller. The farm-level energy buffer circuit is configured to perform a plurality of operations, including but not limited to generating an energy buffer for the wind farm, and applying the energy buffer to the power oscillations generated by the plurality of wind turbine generators so as to decouple the power oscillations generated by the plurality of wind turbine generators from a total output power of the wind farm.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a block diagram of a wind farm having multiple wind turbine generators coupled with a transmission grid according to the present disclosure;

FIG. 2 illustrates a block diagram of suitable components that may be included in an embodiment of a controller according to the present disclosure;

FIG. 3 illustrates a flow diagram of an embodiment of a method for reducing power oscillations generated by a system of inverter-based resources and being injected into an electrical grid according to the present disclosure;

FIG. 4 illustrates a schematic diagram of an embodiment of a farm-level energy buffer circuit for generating an energy buffer according to the present disclosure;

FIG. 5 illustrates a schematic diagram of an embodiment of an algorithm for creating a stiff voltage at a collector bus at certain predetermined frequencies according to the present disclosure; and

FIG. 6 illustrates a schematic diagram of an embodiment of a control structure for a grid-following voltage-source converter according to the present disclosure, wherein new signals have been added to the power reference and voltage reference to achieve the stiff voltage at the collector bus at certain predetermined frequencies.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to a systems and methods for decoupling drivetrain-related power oscillations from the active power injected into the grid, thereby allowing a system of one or more inverter-based resources (IBRs) to manage loading on the drivetrain independent of grid conditions. Accordingly, systems and methods of the present disclosure include a system-level energy buffer circuit that decouples the power oscillations from the IBRs from a total power output of the system (e.g., a wind farm). With the system-level energy buffer circuit, the power oscillations into the grid can be significantly reduced or eliminated by being absorbed by the energy buffer generated by the system-level energy buffer circuit. In particular embodiments, the system-level energy buffer circuit includes a voltage-source converter with energy storage hardware connected to a DC link. Moreover, the system-level energy buffer circuit may have its own transformer that steps up the voltage to the nominal collector bus voltage. To achieve the intended behavior, the system-level energy buffer circuit is controlled in such a way to create a stiff collector bus voltage at predetermined frequencies. By creating this stiff voltage, the changes in power caused by the collective group or system of IBRs are absorbed by the energy buffer without the need of any feedbacks/communication between the energy buffer and the IBRs themselves.

As used herein, a “stiff” voltage may be achieved by either a grid-following or grid-forming IBR, where the creation of the stiff voltage involves controls that oppose changes in voltage at a certain electrical node. Thus, in an embodiment, creation of a stiff voltage at a particular frequency involves a control system that largely prevents or minimizes changes in the voltage magnitude and angle at that frequency. Accordingly, in an embodiment, the IBR creating the stiff voltage supplies the necessary current/power flow to prevent or minimize the changes in voltage magnitude and angle.

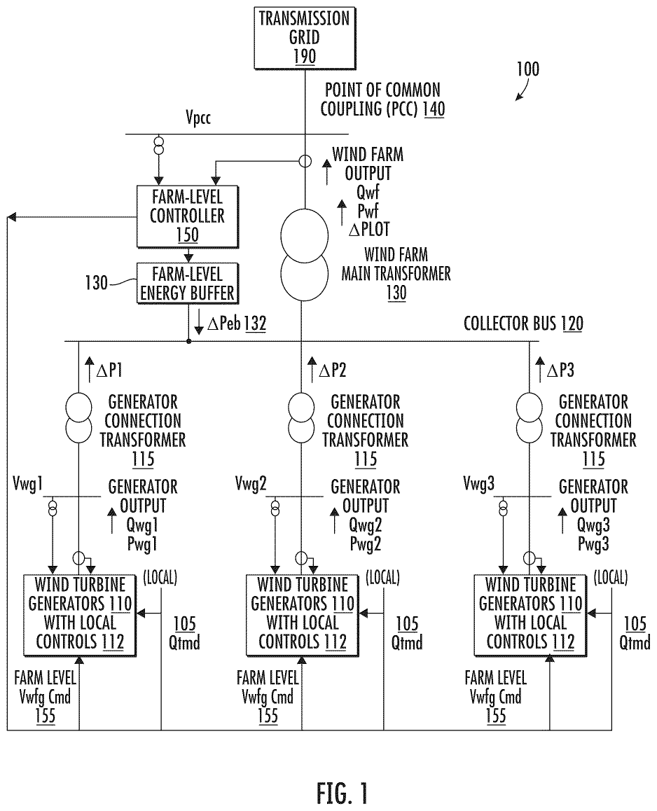

Referring now to the drawings, FIG. 1 illustrates a block diagram of a wind farm 100 having a plurality of wind turbine generators 110 coupled with a transmission grid 190. FIG. 1 illustrates three wind generators 110; however, any number of wind generators can be included in a wind farm 100. Further, as shown, each of the wind turbine generators 110 includes local controls 112 that is responsive to the conditions of the wind turbine generator 110 being controlled. The local controls 112 may include, for example, a turbine controller and/or a converter controller. In one embodiment, the local controls 112 for each wind turbine generator 110 senses only the terminal voltage and current (via potential and current transformers). The sensed voltage and current are used by the local controls 112 to provide an appropriate response to cause the wind turbine generator(s) 110 to provide the desired reactive power.

Each wind turbine generator 110 is coupled to collector bus 120 through generator connection transformers 115 to provide real and reactive power (labeled P_{wg} and Q_{wg}, respectively) to the collector bus 120. Generator connection transformers and collector buses are known in the art.

The wind farm 100 provides real and reactive power output (labeled P_{wf} and Q_{wf}, respectively) via wind farm main transformer 130. The farm-level controller 150, which is communicatively coupled to the local controls 112, senses the wind farm output, as well as the voltage at the point of common coupling (PCC) 140, to provide a Q command signal 105 (Q_{CMD}) that indicates desired reactive power at the generator terminals to ensure a reasonable distribution of reactive power among the wind turbines. In alternate embodiments, the Q command signal (Q_{CMD}) 105 may be generated as the local or operator level (indicated by the “LOCAL” lines in FIG. 1), for example in the event that the wind turbine generator(s) is in manual mode or otherwise not in communication with the wind farm-level controller 150.

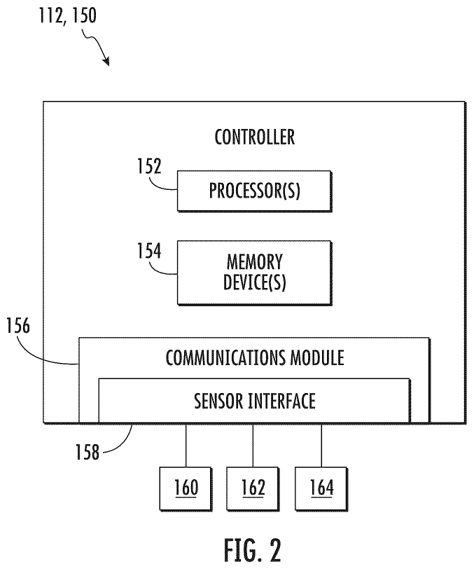

Referring now to FIG. 2, a block diagram of one embodiment of suitable components that may be included within the local controls 112 and/or the farm-level controller 150 in accordance with aspects of the present disclosure is illustrated. As shown, the local controls 112 and/or the farm-level controller 150 may include one or more processor(s) 152 and associated memory device(s) 154 configured to perform a variety of computer-implemented functions (e.g., performing the methods, steps, calculations and the like and storing relevant data as disclosed herein). Additionally, the local controls 112 and the farm-level controller 150 may also include a communications module 156 to facilitate communications between the local controls 112 and/or the farm-level controller 150 and the various components of the wind farm 100. Further, the communications module 156 may include a sensor interface 158 (e.g., one or more analog-to-digital converters) to permit signals transmitted from one or more sensors 160, 162, 164 to be converted into signals that can be understood and processed by the processors 152. It should be appreciated that the sensors 160, 162, 164 may be communicatively coupled to the communications module 156 using any suitable means. For example, as shown, the sensors 160, 162, 164 are coupled to the sensor interface 158 via a wired connection. However, in other embodiments, the sensors 160, 162, 164 may be coupled to the sensor interface 158 via a wireless connection, such as by using any suitable wireless communications protocol known in the art.

As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 154 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 154 may generally be configured to store suitable computer-readable instructions that, when implemented by the processor(s) 152, configure the local controls 112 and/or the farm-level controller 150 to perform various functions as described herein.

The sensors 160, 162, 164 may include any suitable sensors configured to provide feedback measurements to the farm-level controller 150. In various embodiments, for example, the sensors 160, 162, 164 may be any one of or combination of the following: voltage sensors, current sensors, and/or any other suitable sensors.

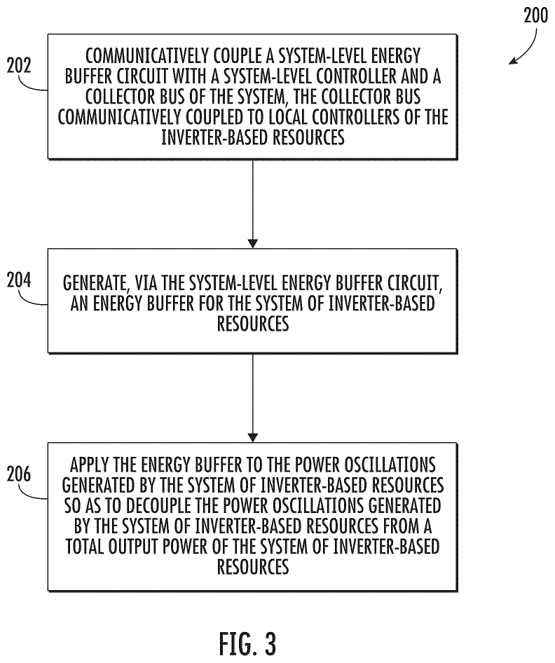

Referring back to FIG. 1, the wind farm 100 further includes a farm-level energy buffer circuit 130 according to the present disclosure. The details of the farm-level energy buffer circuit 130 are described herein with reference to FIGS. 3-6. Accordingly, in an embodiment, a purpose of the farm-level energy buffer circuit 130 is to decouple power oscillations from the wind turbine generators 110 from a total power output of the wind farm 100. Thus, with the farm-level energy buffer circuit 130, the power oscillations into the electrical grid can be significantly reduced and/or eliminated by being absorbed by a change in power 132, represented by ΔPeb. Moreover, in an embodiment, a power rating of the change in power 132 is relatively small with respect to the wind farm power rating, such as from about 5% to about 10% of the wind farm power rating.

Referring particularly to FIGS. 3-6, embodiments of various systems and methods for reducing power oscillations generated by a system of inverter-based resources (such as the wind farm 100) and being injected into an electrical grid according to the present disclosure are illustrated. In particular, FIG. 3 illustrates a flow diagram of one embodiment of a method 200 for reducing power oscillations generated by a system of inverter-based resources and being injected into an electrical grid according to the present disclosure. FIG. 3 depicts steps performed in a particular order for purposes of illustration and discussion. Those of ordinary skill in the art, using the disclosures provided herein, will understand that various steps of any of the methods disclosed herein can be adapted, omitted, rearranged, or expanded in various ways without deviating from the scope of the present disclosure.

As shown at (202), the method 200 includes communicatively coupling a system-level energy buffer circuit, such as the farm-level energy buffer circuit 130, with a system-level controller (e.g., farm-level controller 150). Further, in an embodiment, the system-level controller may be communicatively coupled to local controllers of the inverter-based resources (e.g., wind turbine generators 110 with local controls 112).

As shown at (204), the method 200 includes generating, via the system-level energy buffer circuit, an energy buffer (e.g., achieved through a change in power, ΔPeb, 132) for the system of inverter-based resources. Thus, as shown at (206), the method 200 includes applying the energy buffer to the power oscillations (e.g., ΔP1, ΔP2, ΔP3, etc.) generated by the system of inverter-based resources so as to decouple the power oscillations generated by the system of inverter-based resources from a total output power (e.g., ΔPtot) of the system of inverter-based resources.

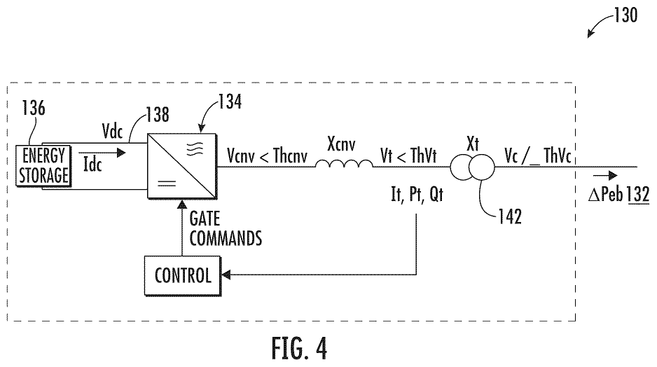

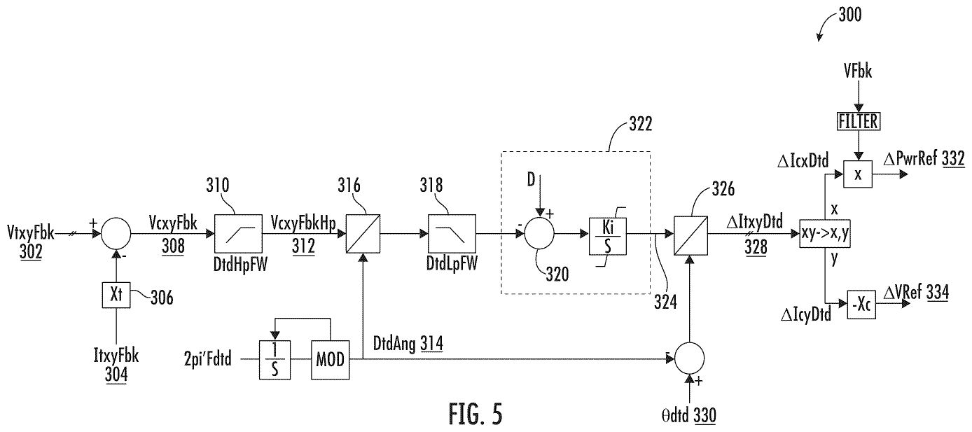

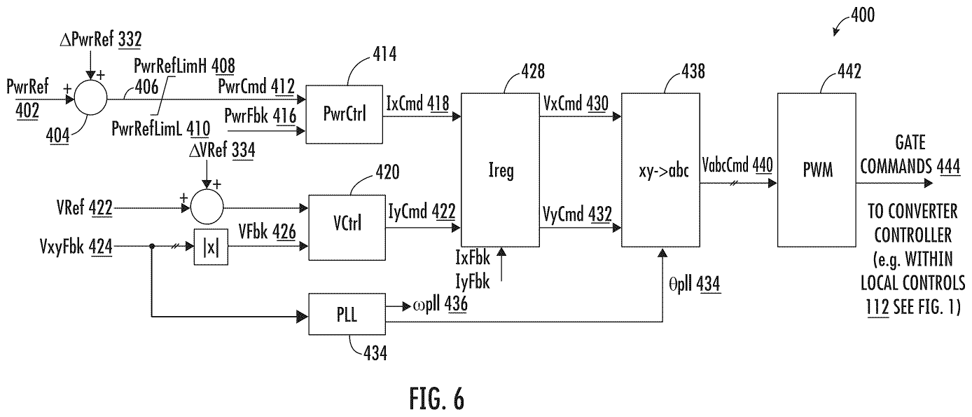

The method 200 of FIG. 3 can be better understood with reference to FIGS. 4-6. FIG. 4 illustrates a schematic diagram of an embodiment of the farm-level energy buffer circuit 130 for generating the change in power 132 according to the present disclosure. Referring now to FIG. 5, a schematic diagram of an embodiment of an algorithm 300 for creating a stiff voltage at the collector bus at certain predetermined frequencies is illustrated according to the present disclosure. FIG. 6 illustrates a schematic diagram of an embodiment of a control structure 400 for a grid-following voltage-source converter according to the present disclosure, wherein new signals have been added to the power reference and voltage reference to achieve the stiff voltage at the collector bus at certain predetermined frequencies. It should be further understood that though FIG. 6 illustrates a grid-following voltage-source converter, similar changes can be equally applied to a grid-forming control structure to achieve similar performance.

As shown particularly in FIG. 4, in an embodiment, the farm-level energy buffer circuit 130 includes a voltage-source converter 134 with energy storage hardware 136 connected to a DC link 138. In particular embodiments, for example, the energy storage hardware 136 may include batteries, capacitors, and/or any other suitable type of energy storage system. Moreover, as shown, the farm-level energy buffer circuit 130 may also have a transformer 142 that steps up the voltage to the nominal collector bus voltage as described in more detail herein below. An output of the farm-level energy buffer circuit 130 is the change in power 132 that decouples the power oscillations generated by the system of inverter-based resources from a total output power (e.g., ΔPtot) of the system, thereby reducing and/or eliminating the power oscillations injected into the electrical grid.

More specifically, to achieve the intended behavior, the farm-level energy buffer circuit 130 is controlled in such a way to create a “stiff” collector bus voltage at predetermined frequencies. By creating this stiff voltage, the changes in power caused by the collective group of inverter-based resources are absorbed by the change in power 132 without the need of any feedbacks and/or communication between the change in power 132 and the inverter-based resources. Similarly, any oscillations in grid frequency or angle at the predetermined frequency can be decoupled from the inverter-based resources, thereby buffering the inverter-based resources from any background oscillations in the electrical grid. This can be particularly important for grid-forming wind turbines, where active power generated is sensitive to these grid oscillations.

Referring particularly to FIG. 5, as mentioned, a schematic diagram of an embodiment of the algorithm 300 for creating a stiff voltage at the collector bus 120 at certain predetermined frequencies according to the present disclosure. In particular, as shown, the algorithm 300 receives receiving one or more voltage or current feedbacks. For example, as shown, the algorithm 300 receives xy voltage and current feedbacks (e.g., VtxyFbk 302 and ItxyFbk 304), which may be calculated based on abc feedback signals and synchronous reference frame transformation. Moreover, as shown, the algorithm 300 is configured to estimate a collector voltage feedback (e.g., VcxyFbk 308) using the impedance 306 of the transformer 142 of the farm-level energy buffer circuit 130 and the voltage and current feedbacks.

Further, in an embodiment, the algorithm 300 includes applying one or more filters to the collector voltage feedback. In particular embodiments, as an example, the algorithm 300 may include applying one or more first filters to the collector voltage feedback to remove one or more direct current (DC) components thereof associated with the fundamental frequency. Moreover, in an embodiment, the algorithm 300 may include applying one or more second filters the collector voltage feedback to remove higher-frequency components not associated with the drivetrain components of one or more of the inverter-based resources.

For example, as shown, the one or more first filters may include a high-pass filter 310 (e.g., DtdHpFW) applied to the collector voltage feedback to remove the DC components associated with fundamental frequency. An output 312 of the high-pass filter 310 is represented as signal VcFbkHp.

Still referring to FIG. 5, the algorithm 300 further includes calculating an angle 314 (e.g., DtdAng) rotating at the predetermined frequency (e.g., Fdtd) associated with the drivetrain of the inverter-based resource(s). Thus, as shown at 316, the algorithm 300 includes rotating the output 312 to a reference frame rotating at the predetermined frequency using the angle 314. In this reference frame, components of the collector voltage oscillating at the predetermined frequency will appear as direct current (DC) signals.

Moreover, as shown, the one or more second filters may include a low-pass filter 318 applied to the rotated collector voltage feedback to remove higher-frequency components not associated with drivetrain components of interest. Further, the algorithm 300 includes using the calculated voltage feedback in an integral controller 322, where, as shown at 320, the intended reference voltage at this frequency is set to 0. An output 324 of the integral controller 322 is a desired current (e.g., ΔItxyDtd) associated with the predetermined frequency. Thus, in an embodiment, as shown at 326, the algorithm 300 includes rotating the desired current 324 back to the synchronous reference frame to obtain signal 328 (e.g., ΔltxyDtd). This rotation may also include a predetermined phase shift setting 330 (e.g., θdtd) that can be tuned for the application. Thus, as shown, the algorithm 300 calculates the change to the power and voltage references 332, 334 (e.g., ΔPwfRef and ΔVRef) based on the desired current.

Referring now to FIG. 6, as mentioned, a schematic diagram of an embodiment of the control structure 400 for a grid-following voltage-source converter according to the present disclosure is illustrated. In particular, as shown, the new signals, which include the change to the power and voltage references 332, 334 (e.g., ΔPwfRef and ΔVRef) to achieve the stiff voltage at the collector bus at certain predetermined frequencies, are illustrated as being implemented into the control structure 400.

In particular, as shown at 404, the control structure 400 receives a power reference (e.g., PwrRef 402) and the change to the power reference signal 332. An output 406 is constrained by equipment limitations (e.g., PwrRefLimH 408 and PwrRefLimL 410) to determine a power command (e.g., PwrCmd 412). Thus, as shown, a power controller 414 receives the power command 412 and a power feedback signal 416 (e.g., PwrFbk) and generates a current command (e.g., IxCmd 418).

In addition, as shown, a voltage controller 420 receives a voltage reference (e.g., VRef 422) that may come from slower VAR regulation functions or plant-level volt/VAR regulators, as well as one or more voltage feedback signals (e.g., VxyFbk 424). As shown at 326, the voltage feedback signals may be first processed to generate a voltage feedback signal (e.g., VFbk 436) that is received by the voltage controller 420. The voltage controller 420 can then also generate a current command (e.g., IyCmd 422). The current commands 418, 422 can then be used by a current regulator 428 to generate respective voltage commands 430, 432 (e.g., VxCmd, VyCmd).

Still referring to FIG. 6, the control structure 400 may also include a phase-locked loop 434 that uses the voltage feedback signal(s) (e.g., VxyFbk 424) to generate a phase-locked loop angle (e.g., θpll 434) and a phase-locked loop angular frequency (e.g., ωpll 436). Thus, as shown, the phase-locked loop angle 434 can be used, as shown at 438, to rotate the voltage commands 430, 432 to abc coordinates so as to generate three-phase voltage commands (e.g., VabcCmd 440). As shown at 442, the voltage command(s) 440 can be modulated using, e.g., pulse width modulation (PWM), to generate gate commands 444 that can be sent to the converter controller (e.g., within the local controls 112 illustrated in FIG. 1) to provide suitable voltage control of the power converter.

Though the systems and methods described herein generally apply to wind farms having a plurality of wind turbines, it should be appreciated that the disclosed systems and methods of the present disclosure may be implemented using any other power system that is configured to supply power for application to a load, such as a power grid, including, for example, a solar power system, a hydropower system, an energy storage power system, or combinations thereof.

Further aspects of the invention are provided by the subject matter of the following clauses:

Clause 1. A method for reducing power oscillations generated by a system of inverter-based resources and being injected into an electrical grid, the method comprising:
communicatively coupling a system-level energy buffer circuit with a system-level controller, the system-level controller communicatively coupled to local controllers of the inverter-based resources;
generating, via the system-level energy buffer circuit, an energy buffer for the system of inverter-based resources; and
applying the energy buffer to the power oscillations generated by the system of inverter-based resources so as to decouple the power oscillations generated by the system of inverter-based resources from a total output power of the system of inverter-based resources.

Clause 2. The method of clause 1, wherein the system-level energy buffer circuit is coupled to a collector bus of the system, the collector bus coupled to the local controllers of the inverter-based resources.

Clause 3. The method of clause 2, wherein the system-level energy buffer circuit comprises a voltage-source converter with energy storage hardware connected to a DC link of the voltage-source converter.

Clause 4. The method of clause 3, wherein the energy storage hardware comprises at least one of one or more batteries or one or more capacitors.

Clause 5. The method of clause 3, wherein the system-level energy buffer circuit comprises a transformer.

Clause 6. The method of clause 5, further comprising controlling the system-level energy buffer circuit to create a stiff collector bus voltage at one or more predetermined frequencies, wherein, by creating the stiff collector bus voltage, the power oscillations generated by the system of inverter-based resources are absorbed by the energy buffer without any feedbacks or communication between the system-level energy buffer circuit and the system of inverter-based resources.

Clause 7. The method of clause 6, wherein oscillations in grid frequency or grid angle at the one or more predetermined frequencies are also decoupled from the system of inverter-based resources, thereby buffering the system of inverter-based resources from background power oscillations in the electrical grid.

Clause 8. The method of clause 6, wherein controlling the system-level energy buffer circuit to create the stiff collector bus voltage at the one or more predetermined frequencies further comprises:
receiving one or more voltage or current feedbacks;
computing a collector voltage feedback as a function of an impedance of the transformer of the energy buffer and the one or more voltage or current feedbacks;
applying one or more filters to the collector voltage feedback;
calculating an angle rotating at a predetermined frequency associated with drivetrain components of one or more of the inverter-based resources;
rotating the collector voltage feedback to a reference frame rotating at the predetermined frequency;
determining, via an integral controller of the system-level energy buffer circuit, a desired current associated with the predetermined frequency using the collector voltage feedback; and
calculating a change to power and voltage references for the voltage-source converter based on the desired current.

Clause 9. The method of clause 8, wherein the one or more voltage or current feedbacks comprise one or more xy voltage and current feedbacks calculated based on abc feedback signals and a synchronous reference frame transformation.

Clause 10. The method of clause 8, wherein controlling the system-level energy buffer circuit to create the stiff collector bus voltage at the one or more predetermined frequencies further comprises:
rotating the desired current back to a synchronous reference frame that includes a tunable predetermined phase shift setting.

Clause 11. The method of clause 8, wherein applying the one or more filters to the collector voltage feedback further comprises:
applying one or more first filters to the collector voltage feedback to remove one or more direct current (DC) components thereof associated with the predetermined frequency; and
applying one or more second filters the collector voltage feedback to remove higher-frequency components not associated with the drivetrain components of one or more of the inverter-based resources.

Clause 12. The method of any of the preceding clauses, wherein the system of inverter-based resources are grid-following inverter-based resources.

Clause 13. The method of any of the preceding clauses, wherein the system of inverter-based resources are grid-forming inverter-based resources.

Clause 14. The method of any of the preceding clauses, wherein a power rating of the energy buffer is from about 5% to about 10% of a power rating of the system of inverter-based resources.

Clause 15. The method of any of the preceding clauses, wherein the system of inverter-based resources is a wind farm comprising a plurality of wind turbines.

Clause 16. A wind farm connected to an electrical grid, comprising:
a plurality of wind turbine generators;
a farm-level controller; and
a farm-level energy buffer circuit for reducing power oscillations generated by the plurality of wind turbine generators and being injected into the electrical grid, the farm-level energy buffer circuit communicatively coupled with the farm-level controller,
wherein the farm-level energy buffer circuit is configured to perform a plurality of operations, the plurality of operations comprising:
generating an energy buffer for the wind farm; and
applying the energy buffer to the power oscillations generated by the plurality of wind turbine generators so as to decouple the power oscillations generated by the plurality of wind turbine generators from a total output power of the wind farm.

Clause 17. The wind farm of clause 16, wherein the farm-level energy buffer circuit comprises a voltage-source converter with energy storage hardware connected to a DC link of the voltage-source converter and a transformer.

Clause 18. The wind farm of clauses 16-17, wherein the plurality of operations further comprise:
controlling the farm-level energy buffer circuit to create a stiff collector bus voltage at one or more predetermined frequencies, wherein, by creating the stiff collector bus voltage, the power oscillations generated by the plurality of wind turbine generators are absorbed by the energy buffer without any feedbacks or communication between the farm-level energy buffer circuit and the plurality of wind turbine generators.

Clause 19. The wind farm of clauses 16-18, wherein controlling the farm-level energy buffer circuit to create the stiff collector bus voltage at the one or more predetermined frequencies further comprises:
receiving one or more xy voltage and current feedbacks calculated based on abc feedback signals and a synchronous reference frame transformation;
computing a collector voltage feedback as a function of an impedance of the transformer of the energy buffer and the one or more voltage or current feedbacks;
applying one or more filters to the collector voltage feedback;
calculating an angle rotating at a predetermined frequency associated with drivetrain components of one or more of the plurality of wind turbine generators;
rotating the collector voltage feedback to a reference frame rotating at the predetermined frequency;
determining, via an integral controller of the farm-level energy buffer circuit, a desired current associated with the predetermined frequency using the collector voltage feedback; and
calculating a change to power and voltage references for the voltage-source converter based on the desired current.

Clause 20. The wind farm of clause 19, wherein controlling the farm-level energy buffer circuit to create the stiff collector bus voltage at the one or more predetermined frequencies further comprises:
rotating the desired current back to a synchronous reference frame that includes a tunable predetermined phase shift setting.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for reducing power oscillations generated by a system of inverter-based resources and being injected into an electrical grid, the method comprising:
communicatively coupling a system-level energy buffer circuit with a system-level controller, the system-level controller communicatively coupled to local controllers of the inverter-based resources;
generating, via the system-level energy buffer circuit, an energy buffer for the system of inverter-based resources; and
applying the energy buffer to the power oscillations generated by the system of inverter-based resources so as to decouple the power oscillations generated by the system of inverter-based resources from a total output power of the system of inverter-based resources.

2. The method of claim 1, wherein the system-level energy buffer circuit is coupled to a collector bus of the system, the collector bus coupled to the local controllers of the inverter-based resources.

3. The method of claim 2, wherein the system-level energy buffer circuit comprises a voltage-source converter with energy storage hardware connected to a DC link of the voltage-source converter.

4. The method of claim 3, wherein the energy storage hardware comprises at least one of one or more batteries or one or more capacitors.

5. The method of claim 3, wherein the system-level energy buffer circuit comprises a transformer.

6. The method of claim 5, further comprising controlling the system-level energy buffer circuit to create a stiff collector bus voltage at one or more predetermined frequencies, wherein, by creating the stiff collector bus voltage, the power oscillations generated by the system of inverter-based resources are absorbed by the energy buffer without any feedbacks or communication between the system-level energy buffer circuit and the system of inverter-based resources.

7. The method of claim 6, wherein oscillations in grid frequency or grid angle at the one or more predetermined frequencies are also decoupled from the system of inverter-based resources, thereby buffering the system of inverter-based resources from background power oscillations in the electrical grid.

8. The method of claim 6, wherein controlling the system-level energy buffer circuit to create the stiff collector bus voltage at the one or more predetermined frequencies further comprises:
receiving one or more voltage or current feedbacks;
computing a collector voltage feedback as a function of an impedance of the transformer of the energy buffer and the one or more voltage or current feedbacks;
applying one or more filters to the collector voltage feedback;
calculating an angle rotating at a predetermined frequency associated with drivetrain components of one or more of the inverter-based resources;
rotating the collector voltage feedback to a reference frame rotating at the predetermined frequency;
determining, via an integral controller of the system-level energy buffer circuit, a desired current associated with the predetermined frequency using the collector voltage feedback; and
calculating a change to power and voltage references for the voltage-source converter based on the desired current.

9. The method of claim 8, wherein the one or more voltage or current feedbacks comprise one or more xy voltage and current feedbacks calculated based on abc feedback signals and a synchronous reference frame transformation.

10. The method of claim 8, wherein controlling the system-level energy buffer circuit to create the stiff collector bus voltage at the one or more predetermined frequencies further comprises:
rotating the desired current back to a synchronous reference frame that includes a tunable predetermined phase shift setting.

11. The method of claim 8, wherein applying the one or more filters to the collector voltage feedback further comprises:
applying one or more first filters to the collector voltage feedback to remove one or more direct current (DC) components thereof associated with the predetermined frequency; and
applying one or more second filters the collector voltage feedback to remove higher-frequency components not associated with the drivetrain components of one or more of the inverter-based resources.

12. The method of claim 1, wherein the system of inverter-based resources are grid-following inverter-based resources.

13. The method of claim 1, wherein the system of inverter-based resources are grid-forming inverter-based resources.

14. The method of claim 1, wherein a power rating of the energy buffer is from about 5% to about 10% of a power rating of the system of inverter-based resources.

15. The method of claim 1, wherein the system of inverter-based resources is a wind farm comprising a plurality of wind turbines.

16. A wind farm connected to an electrical grid, comprising:
a plurality of wind turbine generators;
a farm-level controller; and
a farm-level energy buffer circuit for reducing power oscillations generated by the plurality of wind turbine generators and being injected into the electrical grid, the farm-level energy buffer circuit communicatively coupled with the farm-level controller,
wherein the farm-level energy buffer circuit is configured to perform a plurality of operations, the plurality of operations comprising:
generating an energy buffer for the wind farm; and
applying the energy buffer to the power oscillations generated by the plurality of wind turbine generators so as to decouple the power oscillations generated by the plurality of wind turbine generators from a total output power of the wind farm.

17. The wind farm of claim 16, wherein the farm-level energy buffer circuit comprises a voltage-source converter with energy storage hardware connected to a DC link of the voltage-source converter and a transformer.

18. The wind farm of claim 17, wherein the plurality of operations further comprise:
controlling the farm-level energy buffer circuit to create a stiff collector bus voltage at one or more predetermined frequencies, wherein, by creating the stiff collector bus voltage, the power oscillations generated by the plurality of wind turbine generators are absorbed by the energy buffer without any feedbacks or communication between the farm-level energy buffer circuit and the plurality of wind turbine generators.

19. The wind farm of claim 18, wherein controlling the farm-level energy buffer circuit to create the stiff collector bus voltage at the one or more predetermined frequencies further comprises:
receiving one or more xy voltage and current feedbacks calculated based on abc feedback signals and a synchronous reference frame transformation;
computing a collector voltage feedback as a function of an impedance of the transformer of the energy buffer and the one or more voltage or current feedbacks;
applying one or more filters to the collector voltage feedback;
calculating an angle rotating at a predetermined frequency associated with drivetrain components of one or more of the plurality of wind turbine generators;
rotating the collector voltage feedback to a reference frame rotating at the predetermined frequency;
determining, via an integral controller of the farm-level energy buffer circuit, a desired current associated with the predetermined frequency using the collector voltage feedback; and
calculating a change to power and voltage references for the voltage-source converter based on the desired current.

20. The wind farm of claim 19, wherein controlling the farm-level energy buffer circuit to create the stiff collector bus voltage at the one or more predetermined frequencies further comprises:
rotating the desired current back to a synchronous reference frame that includes a tunable predetermined phase shift setting.
